(19) United States
(12) Patent Application Publication
(10) Pub. No.: US 2003/0068262 A1
(43) Pub. Date: Apr. 10, 2003

(54) New method for the cleaning of air

(76) Inventor: Barry Irving Bloom, New York, NY (US)

Correspondence Address: DR. BARRY I. BLOOM, COLUMBUS CIRCLE STATION, P.O.B. 20796, NEW YORK, NY, 10023, US

(21) Appl. No.: 09/970,941

(22) Filed: Oct. 5, 2001

(51) Int. Cl. B01D 53/38

(52) U.S. Cl. 423/210

(57) ABSTRACT

This machine introduces microwaves as an alternate means of of disinfection, filtration, purification, and sterilization of air, liquids, and solids or any combination thereof that are microwave compatible materials. It is more effective than any othermethods used in the past.

### BACKGROUND

This invention pertains to the feild of disinfection, filtration and purification of air. There are no previous documents related to this invention by similar process. In the past other methods of air filtration, disinfection and purification that have been usedhave a more limited effectiveness or success.

### SUMMARY OF THE INVENTION

This invention uses microwave energy for the use of disinfection, filtration, and purification of air. This invention produces a more effective or better resulting disinfection, filtration, and purification of air than previous methods.

### DETAILED DESCRIPTION OF THE INVENTION

This invention consists of a microwave compatible enclosure of any shape. On the outer perimeter or exterior of the enclosure and communicating with the interior of the enclosure are the units for emitting microwavesinto the central chamberof all intensities. The number and positioning of the microwave emmitting devices varies with the size and shape of theunit. Also, internal core or cores surrounded by microwavable compatible material in which the microwave emitting devices are mounted and communicate with the air chambermay be used. Grids or struts encased in microwave compatible material or consisting of microwave compatible material may also be used with the microwave emmitting deviceswhich are also encased in microwave compatible material. The microwave emittingdevices can then protrude into (in the case of struts or grids) into the interior of the air chamber or be suspeded from (in the case of struts or grids).

At the open ends or partially open endsor at any position in the air propulsion chamber the air propulsion devices are placed or the movement of the atr in the direction desired. The use of fans either singly or multiply in any configuration either on one side of the microwave chamber or both sides of the microwave chamber accomplish this desired movement of air. Also, jet engines on either one end or both ends can be used for the propulsion of air through the microwave chamber. The jet engines can be used singly or multiply in any configuration. Any other method for the movement of air can be employed. The ends of the chamber may be left open or partially openor be perforated or may exist as a grid or any combination of the aforementioned configurations. They may or may not have filtering devices supplementally associated with them. Heating apparatus or heating systems may also be may be associated with them. The flow of air is to be adjustable in intensity of flow and may be continuous or intermittent.

The outer containment of the air filterng machine is of a material of structural integrity strong enough to protect the machine. Also, if the machine is to be placed in a pre existing housing the layer of the pre existing housing may exist as an outer sheath or the machine can be covered in a material with structural integrity strong enough to protect the machine and placed within the pre existing housing.

What I claim my invention is:

1. Air propelled through a microwave active space created in the machine described will be disinfected.

2. Air propelled through a microwave active space created by the machine described will be filtered.

3. Air propelled through a microwave active space created in the machine described will be purified.

4. Air propelled through a microwave active space created in the machine described will be sterilized.
